(19) United States
(12) Patent Application Publication
(10) Pub. No.: US 2021/0132896 A1
(43) Pub. Date: May 6, 2021

(54) LEARNED SILENCING OF HEADPHONES FOR IMPROVED AWARENESS

(71) Applicant: International Business Machines Corporation, Armonk, NY (US)

(72) Inventors: Prach Jerry Chuaypradit, Apex, NC (US); Christy Sue Enterline, Apex, NC (US); Rorie Paul Reyes, Kingston, NY (US)

(21) Appl. No.: 16/672,633

(22) Filed: Nov. 4, 2019

(51) Int. Cl. G06F 3/16; G06F 16/783

(52) U.S. Cl. CPC G06F 3/165; H04R 3/00; G06F 16/7834; G06F 3/167

(57) ABSTRACT

In an approach for determining an interruption event for currently playing media, a processor receives a first external audio external to a media player that a user is listening to. A processor detects a first interruption action from the user of the media player. A processor generates a first acoustic fingerprint, based on the first external audio, which identifies the first external audio. A processor saves the first acoustic fingerprint to a database.

### BACKGROUND

The present disclosure relates generally to the field of audio interruption awareness, and more particularly to determining an interruption event for currently playing media.

Sound recognition is a technology, which is based on both traditional pattern recognition theories and audio signal analysis methods. Sound recognition technologies contains preliminary data processing, feature extraction and classification algorithms. Sound recognition can classify feature vectors. Feature vectors are created as a result of preliminary data processing and linear predictive coding. Sound recognition technologies may be used for music recognition, speech recognition, and automatic alarm detection of an identification for surveillance, monitoring systems, based on the acoustic environment.

### SUMMARY

Aspects of an embodiment of the present disclosure disclose an approach for determining an interruption event for currently playing media. A processor receives a first external audio external to a media player that a user is listening to. A processor detects a first interruption action from the user of the media player. A processor generates a first acoustic fingerprint, based on the first external audio, which identifies the first external audio. A processor saves the first acoustic fingerprint to a database.

### BRIEF DESCRIPTION OF THE DRAWINGS

FIG. 1 is a functional block diagram illustrating an audio interruption awareness environment, in accordance with an embodiment of the present disclosure.

FIG. 2 is a flowchart depicting operational steps of an audio interruption awareness program within a computing device of FIG. 1, in accordance with an embodiment of the present disclosure.

FIG. 3 is a flowchart depicting operational steps of the audio interruption awareness program within the computing device of FIG. 1, in accordance with an embodiment of the present disclosure.

FIG. 4 is a block diagram of components of the computing device of FIG. 1, in accordance with an embodiment of the present disclosure.

### DETAILED DESCRIPTION

The present disclosure is directed to systems and methods for determining an interruption event for currently playing media.

Headphones (e.g., in-ear or over-the-ear) are becoming more prolific in private workspaces and public settings (e.g., commuter trains, schools). It has become increasingly difficult to get someone's attention when people put headphones in, or over, their ears and are listening to media playing, such as music. The present disclosure discloses methods and systems to detect that a user has acted to turn his or her attention to an external audio interruption and learns to automatically take a similar action in the future when the same or a similar external audio interruption is detected. The action taken can include removal of headset or muting/pausing of the playing media. For example, the user may take the action by physically removing the headset entirely off the user's head or ears or removing the headset partially off the user's head or ears. The user may take the action by manually press a button to mute or pause the playing media.

In one or more embodiments, when a user begins to listen to audio using a headset or headphones, the system monitors for “wake words” or triggers (e.g. “Hey Chris”) from a known external acoustic fingerprint from an acoustic fingerprint database. If an acoustic fingerprint is detected and is in an approved list, the system may automatically mute the headset audio and/or pause the playing media. Generally, an acoustic fingerprint is a condensed digital summary, deterministically generated from an audio signal, that can be used to identify an audio sample or quickly locate similar items in an audio database. The system may vibrate the headset in the direction of detected external audio. For example, if the external audio is from the left of the user, the system may vibrate the headset in the direction of detected external audio towards the left. The system may also just vibrate the headset for the left ear of the user. Similarly, if the external audio is from the right of the user, the system may vibrate the headset in the direction of detected external audio towards the right. The system may also just vibrate the headset for the right ear of the user. In another example, if the external audio is from top, bottom, front, or back of the user, the system may vibrate the headset in the direction of detected external audio accordingly.

If no acoustic fingerprint is detected, the system may monitors user activities performed by the user when the user turns an attention to the external audio. The activities indicating the user's attention to the external audio may include the muting of the playing media. The activities indicating the user's attention to the external audio can also include the user's removal of the headset (or a portion of the headset) from the user's ears.

Regardless how the user's attention is diverted to the external audio, the system may save the newly buffered external audio to the acoustic fingerprint database and begin to record additional seconds of the external audio. The user can disable this feature or have to opt in to have their audio or identification information be obtained. The user is in control of what type of information is going to be collected and aware of how that information is going to be used. Once the user resumes listening to the media or replaces the headset over or in their ears, the system ends recording of additional seconds of external audio and stores the newly-captured audio into the acoustic fingerprint database. New audio may be either added to an existing acoustic fingerprint in the acoustic fingerprint database, or new audio may be added to a new, unique fingerprint in the acoustic fingerprint database. If user's attention is diverted for a specific acoustic fingerprint past a set threshold, that acoustic fingerprint may be automatically added to the user's approved list or the user can be asked if the acoustic fingerprint is to be added. For example, the set threshold may be the amount of time (e.g., 15 seconds) that the user mute or pause the playing media. In another example, the set threshold may be a pre-determined threshold that is based on the previous actions from user.

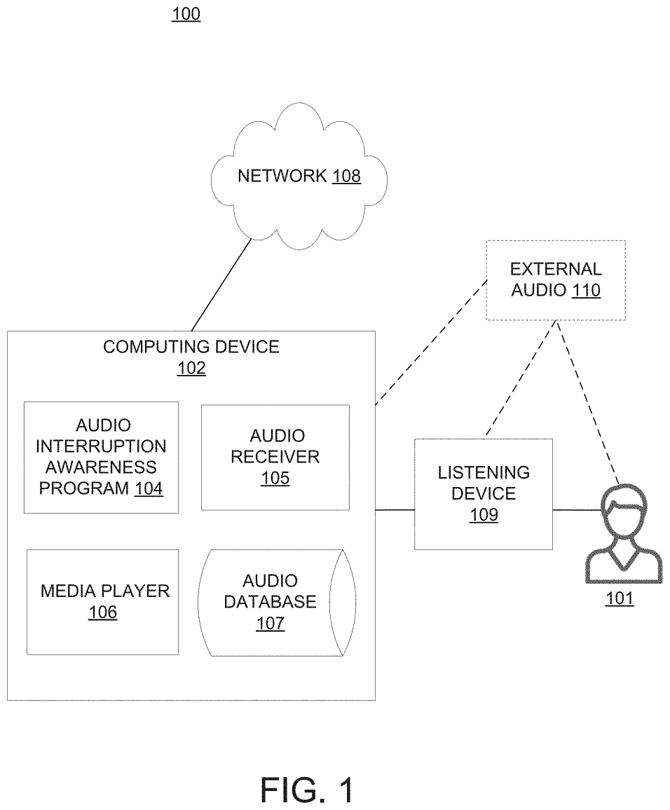

The present disclosure will now be described in detail with reference to the Figures. FIG. 1 is a functional block diagram illustrating an audio interruption awareness environment, generally designated 100, in accordance with an embodiment of the present disclosure.

In the depicted embodiment, audio interruption awareness environment 100 includes computing device 102, listening device 109, and network 108. Audio interruption awareness environment 100 may also include external audio 110. External audio 110 are audios not produced from media player 106 in computing device 102 that user 101 is listening to. For example, external audio 110 may be “wake words” or triggers (e.g. “Hey Chris”) by other individuals, or other audio interruptions (such as a doorbell, telephone ringing, user sneezing, interrupting foreground noises by other individuals). User 101 uses listening device 109 to listen audio played by media player 106 in computer device 102. Listening device 109 can be connected to computer device 102 with a wired cable, wireless, or in any other suitable connection between computer device 102 and listening device 109. Listening device 109 can be connected and accessed through a communication network such as network 108. In the depicted embodiment, listening device 109 is located externally from computing device 102. However, listening device 109 may be located on computing device 102. In one example, listening device 109 is a pair of headphones (e.g., in-ear or over-the-ear). In another example, listening device 109 is a headset. In yet another example, listening device 109 can be any suitable device that user 101 can use to listen to audio from computing device 102. User 101 may put listening device 109 over or in ears of user 101.

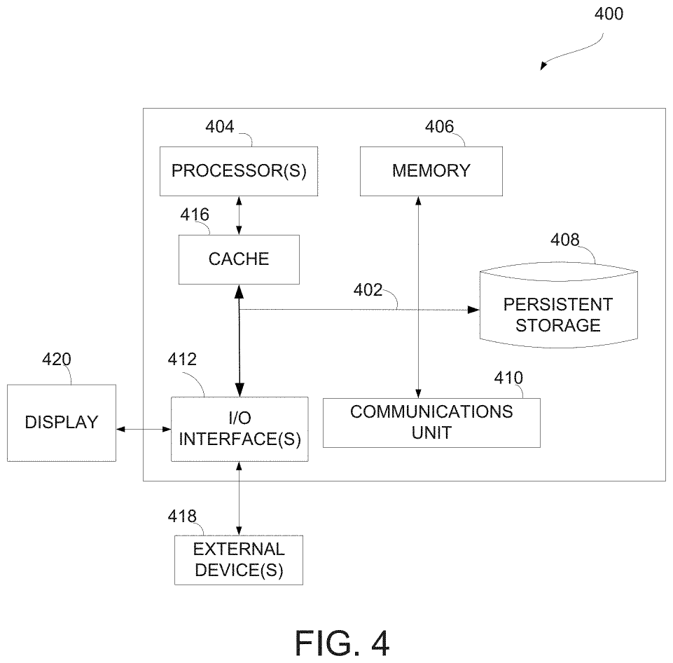

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to audio interruption awareness program 104, audio receiver 105, media player 106, audio database 107, and network 108 and is capable of processing program instructions and executing audio interruption awareness program 104, in accordance with an embodiment of the present disclosure. Computing device 102 may include internal and external hardware components, as depicted and described in further detail with respect to FIG. 4.

Further, in the depicted embodiment, computing device 102 includes audio interruption awareness program 104, audio receiver 105, media player 106, and audio database 107. In the depicted embodiment, audio interruption awareness program 104, audio receiver 105, media player 106, and audio database 107 are located on computing device 102. However, in other embodiments, audio interruption awareness program 104, audio receiver 105, media player 106, and audio database 107 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102, and audio interruption awareness program 104, audio receiver 105, media player 106, and audio database 107, in accordance with a desired embodiment of the disclosure.

In one or more embodiments, audio interruption awareness program 104 is configured to receive and monitor external audio 110 via audio receiver 105. In an example, audio receiver 105 is a microphone that can receive external audio 110. In another example, audio receiver 105 may be any sensing device that can receive external audio 110. In the depicted embodiment, audio receiver 105 is located on computing device 102. However, in other embodiments, audio receiver 105 may be located externally, for example, in listening device 109.

In one or more embodiments, audio interruption awareness program 104 is configured to detect interruption actions from user 101 who is listening to media player 106 and reacts to external audio 110. In an example, the interruption actions from user 101 may be actions of manually pausing or muting listening device 109. In another example, the interruption actions from user 101 may be actions of removal of listening device 109, partially or entirely. In yet another example, the interruption actions from user 101 may be any actions of user 101 in reaction to external audio 110 when listening to media player 106 in computing device 102. Media player 106 is generally a software program or hardware device capable of playing a media file or disc. For example, media player 106 is capable of playing audio files, such as playing an MP3 song file, and video files, such as a short video clip or movie. In another example, media player 106 may play streaming media as well.

In one or more embodiments, audio interruption awareness program 104 is configured to generate acoustic fingerprints which identify external audio 110 when user 101 is listening to media player 106 and reacts to external audio 110. Generally, an acoustic fingerprint is a condensed digital summary, deterministically generated from an audio signal, that can be used to identify an audio sample or quickly locate similar items in an audio database. The acoustic fingerprint may identify audios, songs, melodies and tunes. The acoustic fingerprint is more analogous to a human fingerprint where small variations that are insignificant to the features the fingerprint uses are tolerated. In an example, an acoustic fingerprint algorithm takes into account the perceptual characteristics of the audio. If two files sound alike to the human ear, their acoustic fingerprints should match, even if their binary representations are quite different. Acoustic fingerprints are not hash functions, which must be sensitive to any small changes in the data. Acoustic fingerprints are more analogous to human fingerprints where small variations that are insignificant to the features the fingerprint uses are tolerated. A user can imagine the case of a smeared human fingerprint impression which can accurately be matched to another fingerprint sample in a reference database; acoustic fingerprints work in a similar way. Perceptual characteristics exploited by audio fingerprints may include average zero crossing rate, estimated tempo, average spectrum, spectral flatness, prominent tones across a set of frequency bands, and bandwidth. In an example, a time-frequency graph called spectrogram may be used to represent an acoustic fingerprint for an audio. Any piece of audio can be translated to a spectrogram. Each piece of audio is split into some segments over time. In some cases, adjacent segments share a common time boundary, in other cases adjacent segments might overlap. The result is a graph that plots three dimensions of audio: frequency vs amplitude (intensity) vs time.

In one or more embodiments, audio interruption awareness program 104 is configured to save external audio 110 to audio database 107. In an example, audio interruption awareness program 104 may automatically buffer external audio 110 when receiving external audio 110. When user 101 reacts to external audio 110 and interrupts media player 106, audio interruption awareness program 104 may save buffered external audios and record external audio 110 with additional time till user 101 resumes media player 106. Audio interruption awareness program 104 may save both buffered and recorded external audio 110 to audio database 107. Audio interruption awareness program 104 is configured to save acoustic fingerprints that identify external audios 110 to audio database 107. In an example, audio database 107 includes a list of pre-approved acoustic fingerprints that identify extern audio 110 that user 101 has previously acted to turn his or her attention to the external audio interruption.

In one or more embodiments, audio interruption awareness program 104 is configured to determine that external audio 110 matches an acoustic fingerprint in audio database 107. In an example, external audio 110 matching the acoustic fingerprint means external audio 110 sound alike to the audio that the acoustic fingerprint identifies to user 101. In an example, responsive to external audio 110 matching the acoustic fingerprint, audio interruption awareness program 104 may automatically interrupt media player 106. In another example, responsive to external audio 110 matching the acoustic fingerprint, audio interruption awareness program 104 may automatically interrupt media player 106, if the acoustic fingerprint is approved by user 101 for an automatic interruption. In another example, if a specific saved acoustic fingerprint is in the list of the approved fingerprints of user 101, a valid trigger from the acoustic fingerprint profile can automatically mute or pause media that is currently being streamed to user 101. In an example, audio interruption awareness program 104 may interrupt media player 106 by muting or pausing media player 106. Audio interruption awareness program 104 may further provide a notification of external audio 110 to user 101. For example, audio interruption awareness program 104 may provide the notification by indicating a direction to an origin of external audio 110 to user 101. Audio interruption awareness program 104 may generate a vibration in listening device 109 in a direction to the origin of external audio 110 to user 101. Audio interruption awareness program 104 may save the matched external audio to audio database 107. Audio interruption awareness program 104 may further update the matched acoustic fingerprint based on the matched external audio. In an example, audio interruption awareness program 104 may update the matched acoustic fingerprint based on the currently matched external audio and previously matched external audios in audio database 107. In another example, audio interruption awareness program 104 may generate a new acoustic fingerprint based on the matched external audio and replace the previously matched acoustic fingerprint in audio database 107.

In one or more embodiments, audio interruption awareness program 104 is configured to determine that external audio 110 does not match any acoustic fingerprint in audio database 107. Responsive to external audio 110 not matching any acoustic fingerprint in audio database 107, audio interruption awareness program 104 may monitor and detect an interruption action from user 101 who is listening to media player 106 and reacts to external audio 110. In an example, the interruption action from user 101 is an action of manually pausing or muting listening device 109 by user 101. In another example, the interruption action from user 101 is an action of removal of listening device 109, partially or entirely. Upon detecting the interruption action from user 101, audio interruption awareness program 104 may generate an acoustic fingerprint which identifies the external audio that has caused the interruption action of user 101. Audio interruption awareness program 104 may save the external audio to audio database 107. Audio interruption awareness program 104 may save the generated acoustic fingerprint to audio database 107 and update a list of acoustic fingerprints in audio database 107.

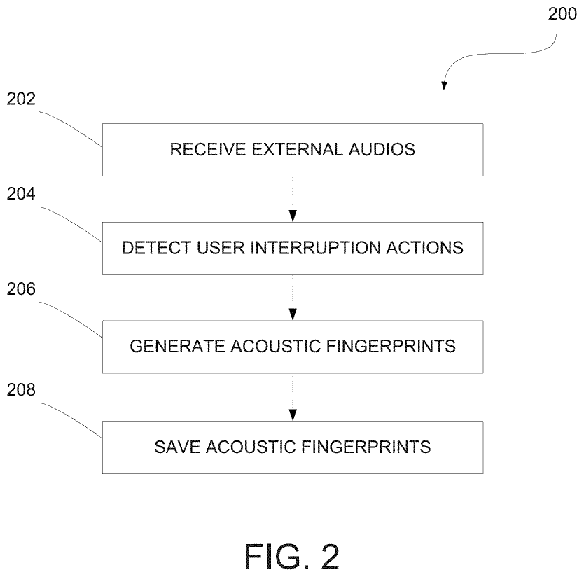

FIG. 2 is a flowchart 200 depicting operational steps of audio interruption awareness program 104 in accordance with an embodiment of the present disclosure.

Audio interruption awareness program 104 operates to receive external audio 110. Audio interruption awareness program 104 also operates to detect interruption actions from user 101 who listens to media player 106 and reacts to external audio 110. Audio interruption awareness program 104 operates to generate an acoustic fingerprint, based on external audio 110, which identifies external audio 110. Audio interruption awareness program 104 operates to save the acoustic fingerprint to audio database 107.

In step 202, audio interruption awareness program 104 receives external audio 110 via audio receiver 105. In an example, audio receiver 105 is a microphone that can receive external audio 110. In another example, audio receiver 105 may be any sensing device that can receive external audio 110.

In step 204, audio interruption awareness program 104 detects interruption actions from user 101 who is listening to media player 106 and reacts to external audio 110. In an example, the interruption actions from user 101 may be actions of manually pausing or muting listening device 109. In another example, the interruption actions from user 101 may be actions of removal of listening device 109, partially or entirely. In yet another example, the interruption actions from user 101 may be any actions of user 101 in reaction to external audio 110 when listening to media player 106 in computing device 102.

In step 206, audio interruption awareness program 104 generates acoustic fingerprints which identify external audio 110 when user 101 is listening to media player 106 and reacts to external audio 110. Generally, an acoustic fingerprint is a condensed digital summary, deterministically generated from an audio signal, that can be used to identify an audio sample or quickly locate similar items in an audio database. The acoustic fingerprint may identify audios, songs, melodies and tunes. The acoustic fingerprint is more analogous to a human fingerprint where small variations that are insignificant to the features the fingerprint uses are tolerated.

In step 208, audio interruption awareness program 104 saves the acoustic fingerprints to audio database 107. Audio interruption awareness program 104 may save external audio 110 to audio database 107. In an example, audio interruption awareness program 104 may automatically buffer external audio 110 when receiving external audio 110. When user 101 reacts to external audio 110 and interrupts media player 106, audio interruption awareness program 104 may save buffered external audio and record external audio 110 with additional time until user 101 resumes media player 106. Audio interruption awareness program 104 may save both buffered and recorded external audio 110 to audio database 107.

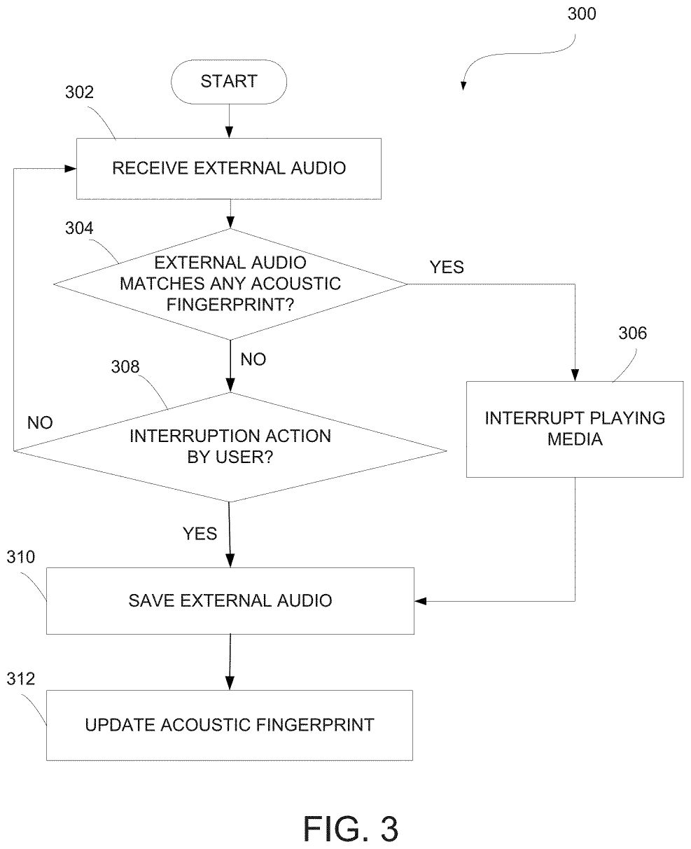

FIG. 3 is a flowchart 300 depicting operational steps of audio interruption awareness program 104 in accordance with an embodiment of the present disclosure.

Audio interruption awareness program 104 operates to receive and monitor external audio 110. Audio interruption awareness program 104 also operates to determine whether the received external audio matches any acoustic fingerprint in audio database 107. Responsive to the received external audio matching an acoustic fingerprint in audio database 107, audio interruption awareness program 104 operates to interrupt media player 106. Responsive to the received external audio not matching any acoustic fingerprint in audio database 107, audio interruption awareness program 104 operates to detect interruption actions from user 101 who listens to media player 106 and reacts to the received external audio. Responsive to an interruption action from user 101, audio interruption awareness program 104 operates to generate an acoustic fingerprint, based on the received external audio. Audio interruption awareness program 104 operates to save the acoustic fingerprint to audio database 107.

In step 302, audio interruption awareness program 104 receives and monitors external audio 110 via audio receiver 105. In an example, audio receiver 105 is a microphone that can receive external audio 110. In another example, audio receiver 105 may be any sensing device that can receive external audio 110.

In step 304, audio interruption awareness program 104 determines whether external audio 110 matches any acoustic fingerprint in audio database 107. If it is determined that external audio 110 matches an acoustic fingerprint (step 304, “Yes” branch), audio interruption awareness program 104 automatically interrupts media player 106. In an example, audio interruption awareness program 104 may interrupt media player 106 by muting or pausing media player 106. Audio interruption awareness program 104 may further provide a notification of external audio 110 to user 101. For example, audio interruption awareness program 104 may provide the notification by indicating a direction to an origin of external audio 110 to user 101. Audio interruption awareness program 104 may generate a vibration in listening device 109 in a direction to the origin of external audio 110 to user 101. In step 310, audio interruption awareness program 104 saves the matched external audio to audio database 107. In step 312, audio interruption awareness program 104 updates the matched acoustic fingerprint based on the matched external audio. In an example, audio interruption awareness program 104 may update the matched acoustic fingerprint based on the currently matched external audio and previously matched external audios in audio database 107. In another example, audio interruption awareness program 104 may generate a new acoustic fingerprint based on the matched external audio and replace the previously matched acoustic fingerprint in audio database 107.

If it is determined that external audio 110 does not match any acoustic fingerprint in audio database 107 (step 304, “No” branch), audio interruption awareness program 104 monitors and detects any interruption action from user 101 as they listen to media player 106 and react to external audio 110. In an example, the interruption action from user 101 is an action of manually pausing or muting listening device 109 by user 101. In another example, the interruption action from user 101 is an action of removing listening device 109, either partially or entirely. If audio interruption awareness program 104 determines that there is no user interruption action resulting from external audio 110 (step 308, “No” branch), audio interruption awareness program 104 operates to continue to receive and monitor external audio 110 via audio receiver 105. If auto interruption awareness program 104 determines a user interruption action is detected (step 308, “Yes” branch), audio interruption awareness program 104 saves the external audio to audio database 107 in step 310. In an example, audio interruption awareness program 104 may automatically buffer external audio 110 when receiving external audio 110. Audio interruption awareness program 104 may save buffered external audio and record external audio 110 with additional time until user 101 resumes media player 106. Audio interruption awareness program 104 may record external audio 110 for a certain time, for example, 10, 20, or 30 seconds for audio interruption awareness program 104 to use the recorded audio. Audio interruption awareness program 104 may save both buffered and recorded external audio 110 to audio database 107. In step 312, audio interruption awareness program 104 may generate an acoustic fingerprint which identifies the external audio that has caused the interruption action of user 101. Audio interruption awareness program 104 may save the generated acoustic fingerprint to audio database 107 and update a list of acoustic fingerprints in audio database 107.

FIG. 4 depicts a block diagram 400 of components of computing device 102 in accordance with an illustrative embodiment of the present disclosure. It should be appreciated that FIG. 4 provides only an illustration of one implementation and does not imply any limitations with regard to the environments in which different embodiments may be implemented. Many modifications to the depicted environment may be made.

Computing device 102 may include communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Audio interruption awareness program 104 may be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Audio interruption awareness program 104 may be downloaded to persistent storage 408 through communications unit 410.

I/O interface(s) 412 allows for input and output of data with other devices that may be connected to audio interruption awareness program 104. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., audio interruption awareness program 104 can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
receiving, by one or more processors, a first external audio external to a media player that a user is listening to;
detecting, by one or more processors, a first interruption action from the user of the media player;
generating, by one or more processors, a first acoustic fingerprint, based on the first external audio, which identifies the first external audio; and
saving, by the one or more processors, the first acoustic fingerprint to a database.

2. The computer-implemented method of claim 1, further comprising:
receiving, by one or more processors, a second external audio;
determining, by one or more processors, that the second external audio matches the first acoustic fingerprint; and
responsive to the second external audio matching the first acoustic fingerprint, interrupting, by one or more processors, the media player.

3. The computer-implemented method of claim 2, further comprising:
saving, by one or more processors, the second external audio to the database; and
updating, by one or more processors, the first acoustic fingerprint based on the second external audio.

4. The computer-implemented method of claim 2, further comprising:
responsive to the second external audio matching the first acoustic fingerprint, providing, by one or more processors, a notification of the second external audio to the user.

5. The computer-implemented method of claim 1, further comprising:
receiving, by one or more processors, a second external audio;
determining, by one or more processors, that the second external audio does not match the first acoustic fingerprint;
detecting, by one or more processors, a second interruption action from the user who is listening to a media player and reacts to the second external audio;
generating, by one or more processors, a second acoustic fingerprint, based on the second external audio, which identifies the second external audio; and
saving, by the one or more processors, the second acoustic fingerprint to the database.

6. The computer-implemented method of claim 1, wherein the first interruption action is selected from the group consisting of: muting the media player, pausing the media player, and removal of a listening device.

7. The computer-implemented method of claim 1, wherein generating the first acoustic fingerprint comprises saving, by one or more processors, the first external audio to the database.

8. A computer program product comprising:
one or more computer readable storage media and program instructions stored on the one or more computer readable storage media, the program instructions comprising:
program instructions to receive a first external audio external to a media player that a user is listening to;
program instructions to detect a first interruption action from the user of the media player;
program instructions to generate a first acoustic fingerprint, based on the first external audio, which identifies the first external audio; and
program instructions to save the first acoustic fingerprint to a database.

9. The computer program product of claim 8, further comprising:
program instructions, stored on the one or more computer-readable storage media, to receive a second external audio;
program instructions, stored on the one or more computer-readable storage media, to determine that the second external audio matches the first acoustic fingerprint; and
program instructions, stored on the one or more computer-readable storage media, responsive to the second external audio matching the first acoustic fingerprint, to interrupt the media player.

10. The computer program product of claim 9, further comprising:
program instructions, stored on the one or more computer-readable storage media, to save the second external audio to the database; and
program instructions, stored on the one or more computer-readable storage media, update the first acoustic fingerprint based on the second external audio.

11. The computer program product of claim 9, further comprising:
program instructions, stored on the one or more computer-readable storage media, responsive to the second external audio matching the first acoustic fingerprint, to provide a notification of the second external audio to the user.

12. The computer program product of claim 8, further comprising:
program instructions, stored on the one or more computer-readable storage media, to receive a second external audio;
program instructions, stored on the one or more computer-readable storage media, to determine that the second external audio does not match the first acoustic fingerprint;
program instructions, stored on the one or more computer-readable storage media, to detect a second interruption action from the user who is listening to a media player and reacts to the third external audio;
program instructions, stored on the one or more computer-readable storage media, to generate a second acoustic fingerprint, based on the second external audio, which identifies the second external audio; and
program instructions, stored on the one or more computer-readable storage media, to save the second acoustic fingerprint to the database.

13. The computer program product of claim 8, wherein the first interruption action is selected from the group consisting of: muting the media player, pausing the media player, and removal of a listening device.

14. The computer program product of claim 8, wherein program instructions to generate the first acoustic fingerprint comprises program instructions, stored on the one or more computer-readable storage media, to save the first external audio to the database.

15. A computer system comprising:
one or more computer processors, one or more computer readable storage media, and program instructions stored on the one or more computer readable storage media for execution by at least one of the one or more computer processors, the program instructions comprising:
program instructions to receive a first external audio external to a media player that a user is listening to;
program instructions to detect a first interruption action from the user of the media player;
program instructions to generate a first acoustic fingerprint, based on the first external audio, which identifies the first external audio; and
program instructions to save the first acoustic fingerprint to a database.

16. The computer system of claim 15, further comprising:
program instructions, stored on the one or more computer-readable storage media, to save the second external audio to the database; and
program instructions, stored on the one or more computer-readable storage media, update the first acoustic fingerprint based on the second external audio.

17. The computer system of claim 16, further comprising:
program instructions, stored on the one or more computer-readable storage media, to save the second external audio to the database; and
program instructions, stored on the one or more computer-readable storage media, update the first acoustic fingerprint based on the second external audio.

18. The computer system of claim 16, further comprising:
program instructions, stored on the one or more computer-readable storage media, responsive to the second external audio matching the first acoustic fingerprint, to provide a notification of the second external audio to the user.

19. The computer system of claim 15, further comprising:
program instructions, stored on the one or more computer-readable storage media, to receive a second external audio;
program instructions, stored on the one or more computer-readable storage media, to determine that the second external audio does not match the first acoustic fingerprint;
program instructions, stored on the one or more computer-readable storage media, to detect a second interruption action from the user who is listening to a media player and reacts to the second external audio;
program instructions, stored on the one or more computer-readable storage media, to generate a second acoustic fingerprint, based on the second external audio, which identifies the second external audio; and
program instructions, stored on the one or more computer-readable storage media, to save the second acoustic fingerprint to the database.

20. The computer system of claim 15, wherein the first interruption action is selected from the group consisting of: muting the media player, pausing the media player, and removal of a listening device.
